(19) United States
(12) Patent Application Publication
(10) Pub. No.: US 2020/0261890 A1
(43) Pub. Date: Aug. 20, 2020

(54) COMPOSITE NANOFIBER CATALYST HAVING IMPROVED LIFESPAN PERFORMANCE AND MANUFACTURING METHOD THEREOF

(71) Applicants: Hyundai Motor Company, Seoul (KR); Kia Motors Corporation, Seoul (KR); Industry-University Cooperation Foundation Hanyang University ERICA Campus, Ansan, (KR)

(72) Inventors: Seung Hyeon Choi, Suwon (KR); Kyung Moon Lee, Uiwang (KR); Dong Hoon Nam, Suwon (KR); Hoon Mo Park, Seongnam (KR); Ji Min Lee, Seoul (KR); Yong Ho Choa, Seongnam (KR); Joo Hyun Park, Anyang (KR)

(21) Appl. No.: 16/653,520

(22) Filed: Oct. 15, 2019

(30) Foreign Application Priority Data
Feb. 19, 2019 (KR) 10-2019-0019162

(51) Int. Cl. B01J 23/10; B01J 21/12; B01J 35/00; B01J 35/10; B01J 35/06; B01J 37/04; B01J 37/08; B01J 37/00; C01B 3/04

(52) U.S. Cl. CPC B01J 23/10; B01J 21/12; B01J 35/006; B01J 35/0066; B01J 35/1014; C01B 3/042; B01J 35/0013; B01J 37/04; B01J 37/08; B01J 37/0018; B01J 35/06

(57) ABSTRACT

Disclosed is a catalyst of a fiber form having improved the lifespan performance while being applied to the oxidation-reduction reaction of a high temperature and a manufacturing method thereof. Particularly, disclosed is a composite nanofiber catalyst including a support having a fiber form and a metal catalyst included in the support and a manufacturing method thereof.

### CROSS-REFERENCE TO RELATED APPLICATION

This application claims under 35 U.S.C. § 119(a) the benefit of priority to Korean Patent Application No. 10-2019-0019162 filed on Feb. 19, 2019, the entire contents of which are incorporated herein by reference.

### TECHNICAL FIELD

The present invention relates to a catalyst having a fiber form and a manufacturing method thereof. The catalyst having a fiber form may have improved lifespan performance while being applied to the oxidation-reduction reaction of a high temperature.

### BACKGROUND

Generally, hydrogen (e.g., hydrogen gas) can be obtained by the electrolysis of water or by the steam reforming or the partial oxidation of fossil fuels. In addition, it can be obtained by the gasification or the carbonization of biomass. Hydrogen manufactured by various methods in the related art is an efficient energy conversion medium, which can be used as a basic raw material in a wide range of fields such as chemical industry and electronic industry, and is a fuel.

Hydrogen is present as a mixture or a compound in a natural state, and the manufacture of hydrogen can variously begin with water, petroleum, coal, natural gas, and combustible waste. A conversion process into hydrogen is possible only by using electricity, heat, microorganisms, etc., and most of various technologies capable of manufacturing hydrogen are in the basic research or the technology development stage. A currently commercialized hydrogen manufacturing method is almost to reform petroleum or natural gas into steam.

For instance, hydrogen can be manufactured by a thermo-chemical technique or by using a photocatalyst or by a biological technique.

FIG. 1 shows a hydrogen manufacturing method through a thermo-chemical technique in the related art. The thermo-chemical technique specifically manufactures hydrogen through a cycle of the oxidation-reduction reaction using a catalyst and heat energy. As shown in FIG. 1, the hydrogen gas is manufactured while the supplied water and catalyst perform the oxidation reaction and the reduction reaction through external heat energy. At this time, the catalyst continuously performs the oxidation and reduction reaction in a reaction space kept at a high temperature, and in this case, the catalyst is partially sintered or phase-separated, and as a result, the efficiency of the oxidation and reduction reaction is reduced, thereby deteriorated the manufacturing yield of hydrogen gas.

In the related art, a catalyst, which continuously performs the oxidation and reduction reaction in a state exposed to a high temperature environment, includes a ceria catalyst.

The above information disclosed in this Background section is only for enhancement of understanding of the background of the disclosure and accordingly it can contain information that does not form the prior art that is already known in this country to a person of ordinary skill in the art.

### SUMMARY OF THE INVENTION

In preferred aspects, provided is a catalyst whose particles may not be agglomerated and sintered even in a state exposed to the high temperature environment. In one aspect, provided is a catalyst, which can improve the efficiency while reducing the content of the ceria metal catalyst containing the rare earth element, thereby improving the economy.

Further, in one aspect, provided is a catalyst, which can provide more reaction zones than the conventional one.

The object of the present disclosure is not limited to the above-described objects. The object of the present disclosure will become more apparent from the following description, and will be realized by means recited the appended claims and a combination thereof.

In one preferred aspect, provided is a composite nanofiber catalyst including a fibrous support; and a metal catalyst included in at least one of the interior and the surface of the fibrous support. The support may include aluminum oxide and silicon oxide.

The term “composite nanofiber” as used herein refers to a complexed material including a nanofiber and one or more distinct materials (e.g., having distinct properties) from the nanofiber. The composite nanofiber has a substantially elongated length compared to the diameter or cross section length of its fibrous structure. Preferably, the composite nanofiber may have a diameter, as measured at the maximum distance connecting two points, less than about 1000 nm, less than about 900 nm, less than about 800 nm, less than about 700 nm, less than about 600 nm, or less than about 500 nm. Preferably, the composite nanofiber may suitably have a size ranging from about 1 nm to 1000 nm, from about 10 nm to 900 nm, from about 10 nm to 800 nm, from about 10 nm to 700 nm, from about 10 nm to 600 nm, or from about 10 nm to 500 nm.

The term “fibrous support” as used herein refers to a solid material that has a rigid or semi-rigid structure and including fibers and elongated shapes like a thread.

The metal catalyst can include cerium oxide (CeO₂).

An average diameter of the metal catalyst may suitably range from about 5 to about 50 nm.

The composite nanofiber catalyst may include the metal catalyst in an amount of about 2.2 to 20.1 wt % and the fibrous support in an amount of about 79.9 to 97.8 wt %, all the wt % are based on the total weight of the composite nanofiber catalyst.

An average specific surface area of the composite nanofiber catalyst may range from about 10.0 to about 60.0 m²/g.

An average thickness of the composite nanofiber catalyst may range from about 100 nm to about 5 μm.

Further provided is a process of water decomposition. The process may include using the composite nanofiber catalyst as described herein and performing an oxidation-reduction at a temperature of about 1000° C. or greater.

In another aspect, provided is method of manufacturing a composite nanofiber catalyst. The method may include preparing a precursor material; preparing a precursor solution by mixing the precursor material with polymer and solvent; preparing an admixture by adding an additive to the precursor solution; electrospinning the admixture through an electrospinning apparatus to produce a spun fiber; and heat-treating the spun fiber to form a composite nanofiber catalyst. Particularly, the composite nanofiber catalyst may include a metal catalyst and a fibrous support, and the fibrous support may include the metal catalyst in any one of the interior and the surface of the fibrous support.

The precursor material may suitably include cerium (II) nitrate hexahydrate (Ce(NO₃)₂.6H₂O), aluminum isopropoxide (Al [OCH(CH₃)₂]₃), aluminum (III) nitrate hexahydrate (Al(NO₃)₃.6H₂O), and tetraethylorthosilicate (SiC₈H₂₀O₄).

The precursor material may suitably include the cerium (II) nitrate hexahydrate, the aluminum isopropoxide, the aluminum (III) nitrate hexahydrate, and the tetraethylorthosilicate at a molar ratio of about 1:44:16:20 to 6:44:16:20.

The polymer may suitably include polyethylene oxide (PEO).

The additive may suitably include polyether-modified hydroxy-functional polydimethylsiloxane.

The additive may suitably be added to the precursor solution in an amount of about 0.2 to 0.8 wt % based on the total weight of the admixture.

The electrospinning in the electrospinning may be performed at a voltage of about 10 to 30 kV and a rate of about 0.1 to 1 mL/h.

The heat treatment may be performed for about 1 to 10 hours at a temperature of about 700 to 1000° C.

Further provided is an apparatus including the composite nanofiber catalyst as described herein. For instance, the apparatus may be used in the process of water decomposition as described herein.

The term “water decomposition” as used herein refers to a process of decomposing (e.g., break down) water molecules into hydrogen molecules and oxygen molecules, for example, by breaking two molecules of water (H₂O) into two molecules of hydrogen (H₂) and one molecule of oxygen (O₂).

Accordingly, provided herein is a catalyst whose particles may not be agglomerated and sintered even in a state exposed to the high temperature environment. Moreover, provided herein is a catalyst, which may improve the efficiency while reducing the content of the ceria metal catalyst containing the rare earth element, thereby improving the economy.

Also provided is a catalyst, which may provide more reaction zones than the conventional one.

Other aspects of the invention are disclosed infra.

### BRIEF DESCRIPTION OF THE DRAWINGS

The above and other features of the present invention will now be described in detail with reference to various exemplary embodiments thereof illustrated the accompanying drawings which are given herein below by way of illustration only, and thus are not limitative of the present disclosure, and wherein:

FIG. 1 shows a conventional hydrogen producing method through a thermo-chemical technique.

FIG. 2 shows an exemplary composite nanofiber catalyst according to an exemplary embodiment of the present invention.

FIG. 3 shows an exemplary manufacturing procedure of the composite nanofiber catalyst according to an exemplary embodiment of the present invention.

FIG. 4A shows analyzed photographs of a Scanning Electron Microscope (SEM) of exemplary spun fibers according to an exemplary embodiment of the present invention.

FIG. 4B shows an X-Ray Diffraction (XRD) for an exemplary spun fiber according to an exemplary embodiment of the present invention.

FIG. 5A shows the analyzed photographs of the Scanning Electron Microscope (SEM) of an exemplary composite nanofiber catalyst heat-treated according to an exemplary embodiment of the present invention.

FIG. 5B shows the X-Ray Diffraction (XRD) for an exemplary composite nanofiber catalyst subject to the heat-treatment at a temperature of 1000° C. according to an exemplary embodiment of the present invention.

FIG. 6 shows the analyzed photographs of the Scanning Electron Microscope (SEM) and the X-Ray Diffraction (XRD) for the composite nanofiber catalyst according to an exemplary embodiment of the present invention.

FIG. 7A shows the analyzed photographs of the Scanning Electron Microscope (SEM) of an exemplary composite nanofiber catalyst heat-treated at a temperature of 600° C. according to an exemplary embodiment of the present invention.

FIG. 7B is the X-Ray Diffraction (XRD) for an exemplary composite nanofiber catalyst subject to the heat-treatment at a temperature of 600° C. according to an exemplary embodiment of the present invention.

FIG. 8 shows the photograph having analyzed exemplary composite nanofiber catalyst subject to the heat-treatment at a temperature of 1000° C. at high magnification through the Scanning Electron Microscope (SEM) according to an exemplary embodiment of the present invention.

FIG. 9 is a diagram illustrating the analyzed photograph of the Scanning Electron Microscope (SEM) and the X-Ray Diffraction (XRD) for a ceria-mullite catalyst of a Comparative Example 2 subject to the heat treatment at a temperature of 1000° C.

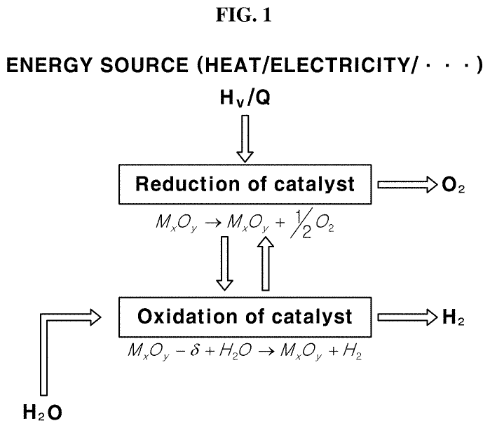

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in section by the particular intended application and use environment.

In the figures, reference numbers refer to the same or equivalent sections of the present invention throughout the several figures of the drawing.

### DETAILED DESCRIPTION

The above-described objects, other objects, features, and advantages of the present invention will be easily understood from the following preferred embodiments relevant to the accompanying drawings. However, the present invention is not limited to the embodiments described herein and can also be embodied in other forms. Rather, the embodiments disclosed herein are provided so that this disclosure will be thorough and complete, and will fully convey the concept of the disclosure to those skilled in the art.

Like reference numerals are used for like components in describing each drawing. In the accompanying drawings, the dimensions of the structures are illustrated in an enlarged scale for clarity of the present invention. The terms first, second, etc. can be used to describe various components, but the components should not be limited by the terms. The terms are used only for distinguishing one component from another. For example, without departing from the scope of the present invention, a first component can be referred to as a second component, and similarly, the second component can also be referred to as the first component. The singular expressions include plural expressions unless the context clearly dictates otherwise.

In this specification, it should be understood that the terms “comprises” or “having” and the like refer to the presence of stated features, integers, steps, operations, components, parts, or a combination thereof, and do not preclude the possibility of the presence or the addition of one or more other features, integers, steps, operations, components, parts, or a combination thereof in advance. In addition, if a portion such as a layer, film, region, plate, or the like is referred to as being “on” another portion, this includes not only the case where it is “directly on” another portion, but also the case where there is another portion therebetween. On the contrary, if a portion such as a layer, film, region, plate or the like is referred to as being “under” another part, it includes not only the case where it is “directly under” another part, but also the case where there is another part therebetween.

Unless otherwise specified, it should be understood that all numbers, values, and/or representations that express the amount of components, reaction conditions, polymer compositions and compounds used in this specification are an approximation that has reflected various uncertainties of the measurement occurred for obtaining these values from the others, which are essentially different therefrom, such that these are expressed by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when a numerical range is disclosed in this specification, such a range is continuous and includes all values from the minimum value of this range to the maximum value including the maximum value unless otherwise indicated. Furthermore, when such a range refers to an integer, all integers including the minimum value to the maximum value including the maximum value are included therein unless otherwise indicated.

In the present specification, it will be understood that when a range is described for a variable, the variable includes all values within the stated range including the end points described in the range. For example, it will be understood that a range of “5 to 10” includes any sub-ranges, such as 6 to 10, 7 to 10, 6 to 9, 7 to 9, etc., as well as values of 5, 6, 7, 8, 9, and 10, and also includes any value between integers that are valid within the scope of the stated ranges such as 5.5, 6.5, 7.5, 5.5 to 8.5, and 6.5 to 9, etc. In addition, for example, it will be understood that a range of “10% to 30%” includes any sub-ranges such as 10% to 15%, 12% to 18%, 20% to 30%, etc., as well as all integers including values of 10%, 11%, 12%, 13%, etc. and 30%, and also includes any value between integers that are valid within the scope of the stated range such as 10.5%, 15.5%, 25.5%, etc.

In one aspect, provided, inter alia, is a composite nanofiber catalyst including a support having a fiber form including aluminum oxide and silicon oxide, and a metal catalyst included in at least one of the interior and the surface of the support and a manufacturing method thereof.

In another aspect, provided is a material of a composite nanofiber catalyst and a manufacturing method of the composite nanofiber catalyst will be described, respectively.

Composite Nanofiber Catalyst

The main purpose of the composite nanofiber catalyst of the present invention may be producing hydrogen and oxygen gases while repeatedly performing the oxidation and reduction reaction with a catalyst used for decomposing water through heat energy.

The composite nanofiber catalyst may include a fibrous support and a metal catalyst. Particularly, the composite nanofiber catalyst may include a support having a fiber form and a metal catalyst included in at least one of the interior and the surface of the support.

The metal catalyst of the present invention may be used for smoothly performing the thermal decomposition reaction of water, and suitably may include cerium oxide (CeO₂).

The average diameter of the metal catalyst may range from about 5 to about 50 nm, and preferably of about 20 to 30 nm.

The support may be suitably used for suppressing the agglomeration between the metal catalysts and keeping the durability of the catalyst even when exposed to the high temperature environment. Preferably, the support may include aluminum oxide (Al₂O₃) and silicon oxide (SiO₂). For example, the support may be a mullite containing at least any one of 3Al₂O₃.2SiO₂ and 2Al₂O₃.SiO₂.

Although it is sufficient that the support of the present disclosure can be a form capable of being fixed so that the agglomeration between the metal catalysts is not made, according to exemplary embodiments of the present invention, the support may suitably a fiber form, which may reduce much more a ratio of the agglomeration between the metal catalysts than the catalyst having a shape in which the metal catalyst such that the support may be simply bonded in the form of particles. In addition, the metal catalyst reaction area may be increased due to the presence of a space between the fibrous supports. The present invention can represent the space between the fibrous supports as a pore, and the water (H₂O) of a liquid or gas form, which is a raw material in a water decomposition process, can be reacted with more metal catalyst while passing through the formed pores.

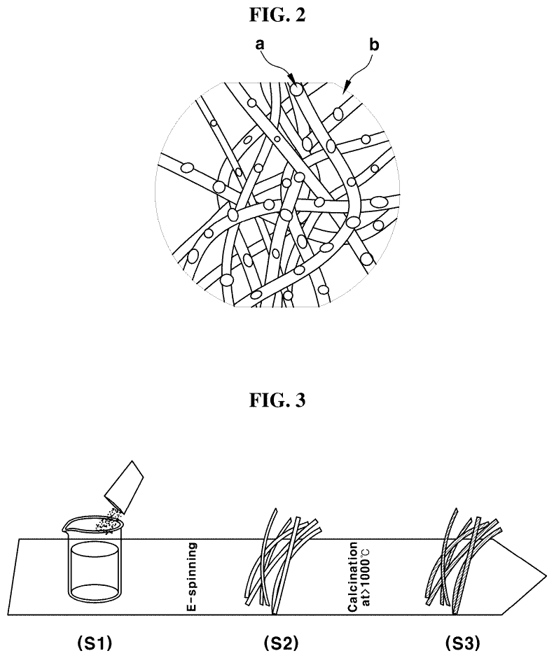

FIG. 2 shows a shape of an exemplary composite nanofiber catalyst of the present invention. As shown in FIG. 2, the composite nanofiber catalyst of the present invention has a shape in which the metal catalyst (a) is attached to the surface of the support having a fiber form or included in the support (b).

The metal catalyst may be suitably contained in an amount of about 2.2 to 20.1 wt % in the composite nanofiber catalyst, and preferably of about 17.3 to 19.7 wt % based on the total weight of the composite nanofiber catalyst. When the content of the metal catalyst is out of the above range, the catalytic effect may be reduced, or the catalytic efficiency may be reduced due to the agglomeration between the metal catalysts.

The support may be suitably contained in an amount of about 79.9 to 97.8 wt % in the composite nanofiber catalyst, and preferably of about 80.3 to 82.7 wt % based on the total weight of the composite nanofiber catalyst.

The average specific surface area of the composite nanofiber catalyst may suitably range from about 10.0 to about 60.0 m²/g. Preferably, the specific surface area may range from about 27.6 to about 30.9 m²/g.

A value of the specific surface area may be influenced by the presence of the impurities such as the agglomerations having a bead shape that is present on the composite nanofiber catalyst, the thickness of the fibrous support such as the thickness of the composite nanofiber catalyst, and the degree of pore formation.

When the specific surface area is less than about 10 m²/g, the area capable of reacting with the metal catalyst may be reduced, and as a result, the yield of producing hydrogen may be reduced through the water decomposition process, and when the specific surface area is greater than about 60.0 m²/g, the durability of the composite nanofiber catalyst may be rather reduced.

An average thickness of the composite nanofiber catalyst may range from about 50 nm to about 2 μm, and preferably from about 175 nm to about 220 nm. When the average thickness is less than about 50 nm, the fibrous shape may not be maintained and the catalyst may be particulated in the heat treatment process. Moreover, when the average thickness is greater than about 2 μm, the metal catalyst may not be protruded from the surface of the support to be positioned only therein, thereby not contacting the external reaction gas, and as a result, the catalyst function is not entirely performed.

The composite nanofiber catalyst of the present invention may be suitably used in the water decomposition process, and specifically performs a function of facilitating the decomposition of water into hydrogen and oxygen in the high temperature environment. In this case, the high temperature environment means the temperature of 1000° C. or greater.

Manufacturing Method of Composite Nanofiber Catalyst

The manufacturing method of the composite nanofiber catalyst of the present invention includes preparing a precursor material; preparing a precursor solution by mixing the precursor material with polymer and solvent; preparing an admixture by adding an additive to the precursor solution; electrospinning the admixture through an electrospinning apparatus to produce a spun fiber; and heat-treating the spun fiber to form a composite nanofiber.

FIG. 3 shows an exemplary process of manufacturing the composite nanofiber catalyst according to an exemplary embodiment of the present invention. Referring to FIG. 3, it will be specifically described for each step.

Preparing

Preparing may include preparing a raw material of the composite nanofiber catalyst, for example, a precursor material.

The precursor material may include cerium (II) nitrate hexahydrate (Ce(NO₃)₂.6H₂O), aluminum isopropoxide (Al [OCH(CH₃)₂]₃), aluminum (III) nitrate hexahydrate (Al(NO₃)₃.6H₂O), and tetraethylorthosilicate (SiC₈H₂₀O₄). Preferably, the precursor material contains cerium (II) nitrate hexahydrate, aluminum isopropoxide, aluminum (III) nitrate hexahydrate, and tetraethylorthosilicate at a molar ratio of about 1:44:16:20 to about 6:44:16:200. When the molar ratio thereof are out of the above range, the byproducts (e.g., CeAl₃, Ce₂SiO₅, and Ce₂Si₂O₇), which reduce the efficiency of the catalyst due to the side reaction, may be formed. These are materials that can cause the sintering and the coarsening of the nanostructure. In addition, when the amount of the cerium (II) nitrate hexahydrate exceeding the molar ratio is injected therein, the agglomeration of the metal catalyst may be generated.

The cerium (II) nitrate hexahydrate (Ce(NO₃)₂.6H₂O) as used herein may provide the cerium contained in the metal catalyst in manufacturing the composite nanofiber catalyst, the aluminum isopropoxide (Al [OCH(CH₃)₂]₃) and the aluminum (III) nitrate hexahydrate (Al(NO₃)₃.6H₂O) as used herein may provide aluminum oxide contained in the support, and the tetraethylorthosilicate (SiC₈H₂₀O₄) as used herein may provide silicon oxide contained in the support. Alternatively, mullite (Al₂O₃.SiO₂) that appears in the form of an alloy of aluminum oxide and silicon oxide may suitably be provided.

First Mixing S1

First mixing may be performed to mix by injecting the precursor material prepared at a certain molar ratio into the prepared pure water S1. For instance, a precursor solution may be manufactured by further injecting polymer and solvent into the pure water into which the precursor material has been injected.

The polymer may be injected for adjusting the viscosity of the precursor solution, and at this time, the thickness of the composite nanofiber catalyst finally manufactured may be changed according to the viscosity of the solution. Preferably, the polymer may include polyethylene oxide (PEO). For instance, the polyethylene oxide may be provided by mixing with ethanol prepared separately.

The polymer may be injected therein by about 0.1 to 4.0 wt % based on the total weight of the precursor solution. Preferably, polymer may be injected therein in an amount of about 2.0 to 3.0 wt % based on the total weight of the precursor solution. When the content of the polymer is less than about 0.1 wt %, a fibrous structure in the electrospinning may not be formed because sufficient viscosity has not been obtained.

The solvent preferably may include anhydrous ethanol.

The mixing may be preferably performed at a temperature of about 50 to 90° C.

Second Mixing

Second mixing may be performed to manufacture an admixture (e.g., a mixed solution) by injecting an additive into the precursor solution prepared by being sufficiently mixed.

The additive may be selected from one of the surfactants, and the additive preferably may include polyether-modified hydroxyl-functional polydimethylsiloxane.

The additive may be preferably injected therein to become 0.2 to 0.8 wt % based on the total weight of the admixture. When the content of the additive is less than about 0.2 wt %, the solution may not be sufficiently discharged due to a high surface tension of the precursor solution in the electrospinning. When the content of the additive is greater than about 0.8 wt %, the additive material may remain in the heat-treating, thereby disturbing the crystallization of the metal catalyst and the support.

Electrospinning S2

Electrospinning may be performed to manufacture a spun fiber by electrospinning, for example, by using an electrospinning apparatus, in order to make the manufactured mixed solution as a catalyst having a fiber form S2.

The mixed solution before the electrospinning may be in a state that contains the precursor material, the polymer, and the additive, and the precursor material may be a state that has been uniformly dispersed in the mixed solution. At this time, when the mixed solution is spun through the electrospinning apparatus, it may be spun on the fiber in a state where the components have been uniformly mixed and finally, the metal catalyst may have a shape that is included in any one of the interior and the surface of the support.

The electrospinning may preferably be performed in the condition of a voltage of about 10 to 30 kV at a rate of about 0.1 to 1 mL/h.

Heat-Treating S3

Heat treating may be performed to manufacture a composite nanofiber catalyst by removing the impurities except for the metal catalyst and the support, for example, by finally heat-treating the spun fiber having a fiber form S3. Particularly, the polymer, the nitrate, etc. may be decomposed by the heat treatment and the composite nanofiber catalyst only containing the cerium oxide (CeO₂), aluminum oxide, and silicon oxide may be obtained.

The heat treatment may be preferably performed at a temperature of about 700 to 1000° C., and may be performed for about 1 to 10 hours. Particularly, the heat treatment may be performed at a temperature of about 800 to 1000° C. When the heat treatment is performed at a temperature of less than about 700° C., there is a risk of manufacturing the catalyst whose efficiency reduces because the impurities are not removed properly, the crystallization is not performed properly, or the agglomeration between cerium oxides occurs. In addition, the process efficiency reduces when the heat treatment is performed at a temperature greater than about 1000° C.

Hereinafter, the Example and the Comparative Example of the present disclosure will be described in detail. The Example and the Comparative Example are only for illustrating the present disclosure, and the present disclosure is not limited to the following example.

Manufacturing Example

The precursor material was prepared by dissolving cerium (II) nitrate hexahydrate (Ce(NO₃)₂.6H₂O), aluminum isopropoxide (Al [OCH(CH₃)₂]₃), aluminum (III) nitrate hexahydrate (Al(NO₃)₃.6H₂O), and tetraethylorthosilicate (SiC₈H₂₀O₄) in 4 mL of the pure water at a molar ratio of 5.5:44:16:20, respectively, and a precursor solution was manufactured by adding 4 mL of anhydrous ethanol thereto and mixing it uniformly. The polymer was prepared by dissolving 0.3 g of the PEO polymer in 1 mL of ethanol, and the mixed solution was manufactured by injecting it together with 45 μL of polyether-modified hydroxy-functional polydimethylsiloxane, which is an additive, into the precursor solution. The mixed solution was contained in a syringe of the electrospinning apparatus and the mixed solution was continuously pushed at a rate of 0.6 mL/h by using a syringe pump. At this time, the spun fiber was manufactured by applying a high voltage (18 kV) thereto while keeping the distance between the tip portion of the syringe and the collector where the spun fiber was deposited at 15 cm and electrospin the mixed solution on the collector by a potential difference.

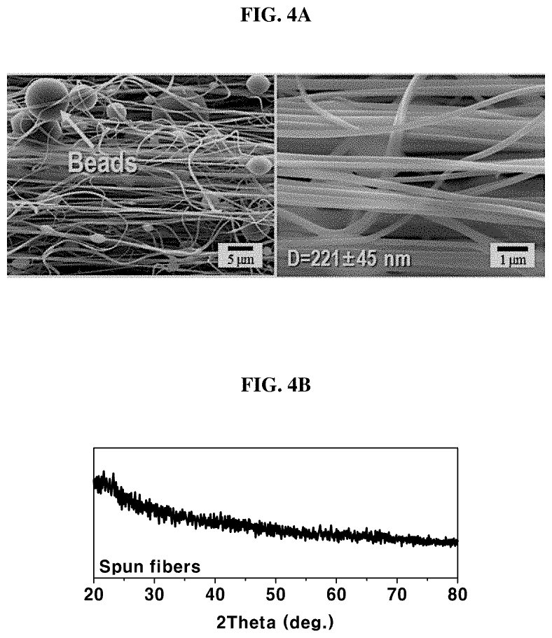

FIG. 4A shows a photographs that have photographed the manufactured spun fiber at high magnification and low magnification by the Scanning Electron Microscopy (SEM). Also shown in FIG. 4B shows an X-Ray Diffraction (XRD) for a spun fiber. As shown in FIG. 4A and FIG. 4B, it can be confirmed that it is yet in an amorphous state and many bead-shaped agglomerations containing polymer are also found.

### Example 1

A composite nanofiber catalyst was obtained by collecting the spun fiber deposited on the collector in the Manufacturing Example in an alumina (Al₂O₃) crucible and heat-treated at a temperature of about 1000° C. for 3 hours in the atmosphere.

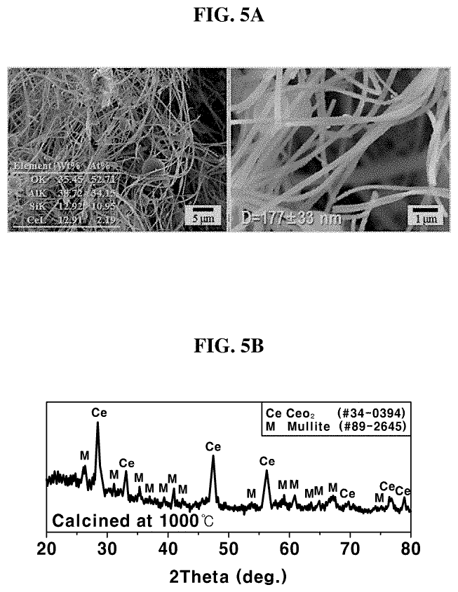

FIG. 5A shows the photographs that have photographed the composite nanofiber catalyst heat-treated at a temperature of 1000° C. at high magnification and low magnification by the Scanning Electron Microscopy (SEM), and FIG. 5B shows the X-Ray Diffraction (XRD) for the composite nanofiber catalyst subject to the heat-treatment at 1000° C. As shown in FIGS. 5A and 5B, it can be confirmed that the crystallization of the composite nanofiber catalyst containing cerium oxide (CeO₂) and mullite (Al₂O₃.SiO₂) was properly performed, and the bead-shaped agglomerations were almost disappeared by the heat treatment.

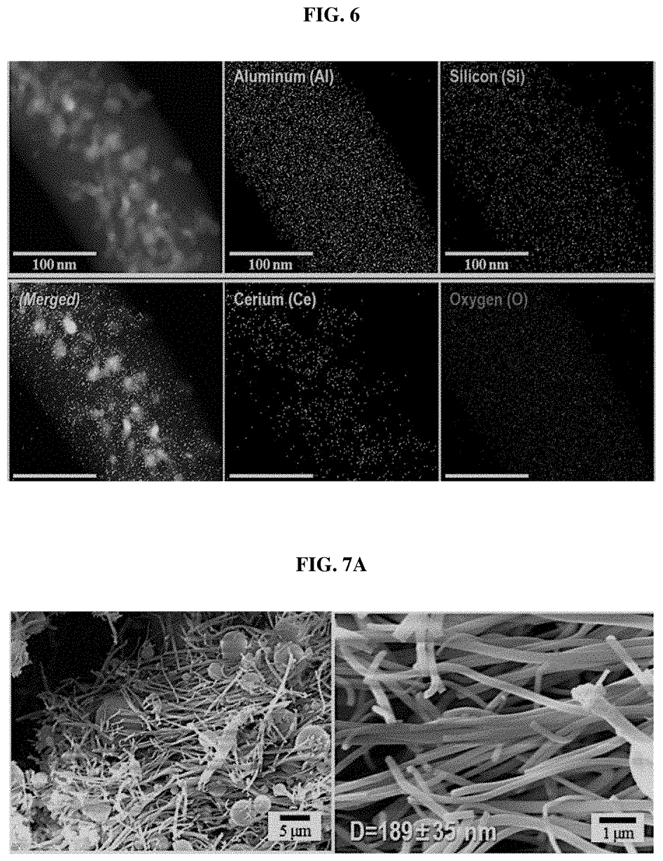

FIG. 6 shows the analyzed photograph of the X-ray spectrometer for observing whether aluminum (Al), silicon (Si), cerium (Ce) and oxygen (O) are contained in the manufactured composite nanofiber catalyst and the distribution properties thereof. As shown in FIG. 6, it can be seen that aluminum, silicon, and oxygen were entirely and uniformly dispersed throughout all zones of the composite nanofiber catalyst and the cerium was dispersed by forming several certain zones on the composite nanofiber catalyst.

### Comparative Example 1

A composite nanofiber catalyst was obtained by collecting the spun fiber deposited on the collector in the Manufacturing Example in the alumina (Al₂O₃) crucible and heat-treated at a low temperature of about 600° C. for 3 hours in the atmosphere.

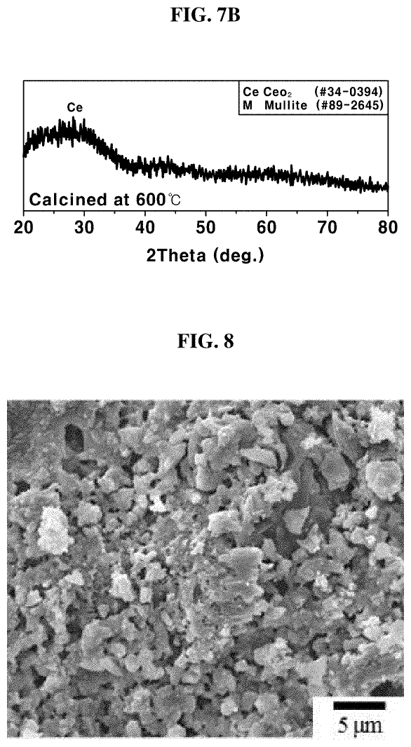

FIG. 7A shows the photographs that have photographed the composite nanofiber catalyst heat-treated at a temperature of 600° C. at high magnification and low magnification by the Scanning Electron Microscopy (SEM), and FIG. 7B shows the X-Ray Diffraction (XRD) for the composite nanofiber catalyst subject to the heat-treatment at 600° C. As shown in FIGS. 7A and 7B, it can be confirmed that the size of the bead-shaped agglomerations became smaller than that of the agglomerations observed at the spun fiber as a temperature of the heat treatment is higher, and at the same time, it can be confirmed that the crystallization of cerium oxide (CeO₂) and mullite (Al₂O₃.SiO₂) are performed.

### Comparative Example 2

A cerium oxide (CeO₂)-mullite (3Al₂O₃.2SiO₂) nano-particle catalyst was obtained by heat-treating the mixed solution manufactured in the Manufacturing Example at a temperature of about 1000° C. for 3 hours in the atmosphere.

FIG. 8 shows the photograph that has analyzed the manufactured cerium oxide (CeO₂)-mullite (3Al₂O₃.2SiO₂) catalyst by the Scanning Electron Microscope (SEM). As shown in FIG. 8, it can be confirmed that the mullite particles containing cerium oxide, aluminum oxide, and silicon oxide are not agglomerated and are dispersed in the form of particles.

### Comparative Example 3

A cerium oxide (CeO₂) catalyst was obtained by manufacturing in the same manner as in the Example 2 except for the preparing the precursor material without using aluminum isopropoxide (Al [OCH (CH₃)₂]₃), aluminum (III) nitrate hexahydrate Al(NO₃)₃.6H₂O), and tetraethyl orthosilicate (TEOS).

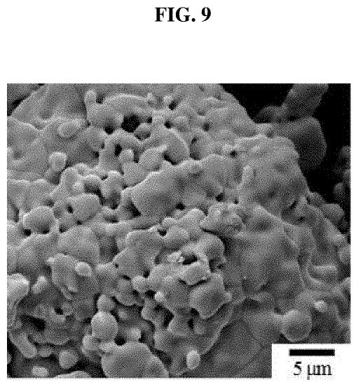

FIG. 9 shows the photograph that has analyzed the manufactured cerium oxide (CeO₂) catalyst by the Scanning Electron Microscope (SEM). As shown in FIG. 9, it can be confirmed that the cerium oxide particles are agglomerated with each other and the surface area of the catalyst is reduced.

### Experimental Example 1

Measured was whether hydrogen has been produced by the water decomposition by using each catalyst manufactured in Example 1, and Comparative Example 1 to Comparative Example 3, and the results were illustrated in Table 1 below.

Specifically, a 500 ml reactor was prepared to inject the catalysts of Example 1 and Comparative Example 1 to Comparative Example 3 into the reactor by 3.0 g, respectively, and the reactor was heated at a temperature of 1400° C. under the inert argon atmosphere to flow 10 ml of water therein, thereby vaporizing it. The thermal decomposition reaction of water occurs as the catalyst is oxidized, 1 cc of air was collected in the reactor by using a syringe every time the reaction was completed, and the amount of produced hydrogen was measured by putting the collected air into the gas chromatography-mass spectrometry. After the reaction was completed, the reduction of the catalyst was sufficiently performed in the inert atmosphere, and 10 ml of water was injected therein again so that the catalytic reaction was occurred. The procedure was repeated five times, and the amount of produced hydrogen obtained for each cycle was illustrated in Table 1 below.

TABLE 1

| | | Comparative | Comparative | Comparative |
|---|---|---|---|---|
| | Example 1 | Example 1 | Example 2 | Example 3 |
| First | 4.50 mL/g_{Ceria} | 3.88 mL/g_{Ceria} | 3.91 mL/g_{Ceria} | 3.04 mL/g_{Ceria} |
| Second | 4.21 mL/g_{Ceria} | 3.79 mL/g_{Ceria} | 3.56 mL/g_{Ceria} | 1.32 mL/g_{Ceria} |
| Third | 4.33 mL/g_{Ceria} | 3.78 mL/g_{Ceria} | 3.36 mL/g_{Ceria} | 0.33 mL/g_{Ceria} |
| Fourth | 4.29 mL/g_{Ceria} | 3.73 mL/g_{Ceria} | 2.98 mL/g_{Ceria} | 0.23 mL/g_{Ceria} |
| Fifth | 4.30 mL/g_{Ceria} | 3.72 mL/g_{Ceria} | 2.37 mL/g_{Ceria} | 0.09 mL/g_{Ceria} |

As shown in Table 1, it can be confirmed that the amount of produced hydrogen by the composite nanofiber catalyst of Example 1 manufactured by the manufacturing method of the present invention was significantly greater than those of other Comparative Examples.

In order to confirm the lifespan performance of the composite nanofiber catalyst of the present disclosure, repeated experiments were performed with the same catalyst, and in the case of Comparative Example 1 and Comparative Example 2, 3.88 mL/g and 3.91 mL/g of the amounts of produced hydrogen are illustrated in the first experiment, respectively, but since then, it can be seen that the amount of produced hydrogen is steadily reduced.

In the case of Comparative Example 3 using only the metal catalyst particles without the support, 3.04 mL/g of the amount of produced hydrogen is illustrated in the first experiment, but since then, it can be seen that the effect of the catalyst is abruptly reduced from the second experiment.

It can be seen that in the case of the Comparative Examples, the effect of the catalyst is reduced as the experiment is repeated, while Example 1 keeps the catalyst performance of 95% or more even when the number of repeated experiments is increased.

The reason why the amount of produced hydrogen and the durability of Comparative Example 1 having a form similar to that of Example 1 are reduced may be the difference in size of the bead-shaped agglomerations and the difference in the surface areas of the metal catalyst attached to the support due to the temperature difference of the heat treatment.

### Experimental Example 2

After the completion of each cycle in Experimental Example 1, the specific surface area of the catalyst was measured by taking the minute amount of catalyst powder, and the results were illustrated in Table 2 below.

TABLE 2

| | | Comparative | Comparative | Comparative |
|---|---|---|---|---|
| | Example 1 | Example 1 | Example 2 | Example 3 |
| First | 29.6132 m²/g | 21.3379 m²/g | 23.6060 m²/g | 16.6490 m²/g |
| Second | 30.0393 m²/g | 20.3150 m²/g | 19.5832 m²/g | 4.4381 m²/g |
| Third | 28.8801 m²/g | 22.6524 m²/g | 17.6272 m²/g | 1.6019 m²/g |
| Fourth | 29.7439 m²/g | 20.5647 m²/g | 14.2883 m²/g | 0.3877 m²/g |
| Fifth | 29.2348 m²/g | 21.0901 m²/g | 11.2095 m²/g | 0.4510 m²/g |

As shown in Table 2, it can be seen that the specific surface area of the composite nanofiber catalyst of the Example 1 has a very high value of 28 m²/g or more, and in addition, even when the cycle is repeated, the specific surface area has almost no change.

In the case of Comparative Example 1, it can be confirmed that even when the cycle is repeated, the specific surface area has almost no change, but the size of the specific surface area is smaller than that of Example 1. As described above, the results that the specific surface area in Comparative Example 1 has almost no change seems to be because the catalyst of Comparative Example 1 has a form in which the metal catalyst is supported on the same fibrous support as in Example 1.

Although it was illustrated in Comparative Example 2 that the specific surface area of the catalyst powder collected in the first experiment had relatively a high value, the specific surface area thereof was reduced by more than half as the experiment was repeated two or more times. This seems to be because the agglomeration between the metal catalysts occurred as the metal catalyst contained in the catalyst powder was repeatedly exposed at a high temperature.

It can be confirmed that in the case of Comparative Example 3, the lowest value of the specific surface area is illustrated and as the experiment is repeated, a value of the specific surface area is remarkably reduced.

As described above, although the various exemplary embodiments of the present invention have been described in detail with reference to the drawings, the present invention is not limited to the above-described embodiments, and various modifications can be made without departing from the technical scope of the present invention.

What is claimed is:

1. A composite nanofiber catalyst, comprising:
a fibrous support; and
a metal catalyst included in at least one of the interior and the surface of the fibrous support,
wherein the support comprises aluminum oxide and silicon oxide.

2. The composite nanofiber catalyst of claim 1,
wherein the metal catalyst comprises cerium oxide (CeO₂).

3. The composite nanofiber catalyst of claim 1,
wherein an average diameter of the metal catalyst ranges from about 5 to about 50 nm.

4. The composite nanofiber catalyst of claim 1,
wherein the composite nanofiber catalyst comprises the metal catalyst in an amount of about 2.2 to 20.1 wt % and the fibrous support in an amount of about 79.9 to 97.8 wt %, all the wt % based on the total weight of the composite nanofiber catalyst.

5. The composite nanofiber catalyst of claim 1,
wherein an average specific surface area of the composite nanofiber catalyst ranges from about 10.0 to about 60.0 m²/g.

6. The composite nanofiber catalyst of claim 1,
wherein an average thickness of the composite nanofiber catalyst ranges from about 100 nm to about 5 μm.

7. A process of water decomposition comprising,
using the composite nanofiber catalyst of claim 1 and performing an oxidation-reduction at a temperature of about 1000° C. or greater.

8. A method of manufacturing a composite nanofiber catalyst, comprising:
preparing a precursor material;
preparing a precursor solution by mixing the precursor material with polymer and solvent;
preparing an admixture by adding an additive to the precursor solution;
electrospinning the admixture to produce a spun fiber; and
heat-treating the spun fiber to form a composite nanofiber catalyst,
wherein the composite nanofiber catalyst comprises a metal catalyst and a fibrous support, and
wherein the fibrous support comprises the metal catalyst in any one of the interior and the surface of the fibrous support.

9. The method of claim 8,
wherein the precursor material comprises cerium (II) nitrate hexahydrate (Ce(NO₃)₂.6H₂O), aluminum isopropoxide (Al [OCH(CH₃)₂]₃), aluminum (III) nitrate hexahydrate (Al(NO₃)₃.6H₂O), and tetraethylorthosilicate (SiC₈H₂₀O₄).

10. The method of claim 9,
wherein the precursor material comprises the cerium (II) nitrate hexahydrate, the aluminum isopropoxide, the aluminum (III) nitrate hexahydrate, and the tetraethylorthosilicate at a molar ratio of about 1:44:16:20 to 6:44:16:20.

11. The method of claim 8,
wherein the polymer in the first mixing comprises polyethylene oxide (PEO).

12. The method of claim 8,
wherein the additive comprises polyether-modified hydroxy-functional polydimethylsiloxane.

13. The method of claim 8,
wherein the additive is added to the precursor solution in an amount of about 0.2 to 0.8 wt % based on the total weight of the admixture.

14. The method of claim 8,
wherein the electrospinning is performed at a voltage of about 10 to 30 kV and a rate of about 0.1 to 1 mL/h.

15. The method of claim 8,
wherein the heat-treating is performed for about 1 to 10 hours at a temperature of about 700 to 1000° C.

16. An apparatus comprising a composite nanofiber catalyst of claim 1.
